(19) United States
(12) Patent Application Publication
(10) Pub. No.: US 2023/0226938 A1
(43) Pub. Date: Jul. 20, 2023

(54) ELECTRIFIED VEHICLE CHARGING PERFORMANCE

(71) Applicant: Ford Global Technologies, LLC, Dearborn, MI (US)

(72) Inventors: Kevin MACKENZIE, Canton, MI (US); Jonathan BARKER, Detroit, MI (US)

(73) Assignee: Ford Global Technologies, LLC, Dearborn, MI (US)

(21) Appl. No.: 17/577,820

(22) Filed: Jan. 18, 2022

(51) Int. Cl. B60L 53/53; B60L 53/65; B60L 58/12; B60W 20/20

(52) U.S. Cl. CPC B60L 53/53; B60L 53/65; B60L 58/12; B60W 20/20

(57) ABSTRACT

An electrified vehicle includes a controller in communication with an on-board charger configured to charge a traction battery from an external power source, the traction battery being configured to power an electric machine that provides propulsive torque to vehicle wheels, the controller programmed to generate an alert message identifying an alternative external power source that would reduce a difference between (a) power requested by the controller, and (b) power currently being delivered by the external power source when the difference exceeds a configurable threshold.

### TECHNICAL FIELD

This disclosure generally relates to a system and method for controlling an electrified vehicle during battery charging from an external source.

### BACKGROUND

Electrified vehicle users may have numerous options for charging an on-board traction battery that may affect selection of a particular charging location including but not limited to hardware compatibility, power level, charging network account or subscription, charging time and/or fees, etc. For example, charging options may include Level 1 (120 VAC), Level 2 (208-240 VAC), and Level 3 (400-900 VDC) charging but may also depend on compatibility of the particular plug/receptacle hardware of the charging station and electrified vehicle. Even if the charging hardware is compatible, charging station configurations (maximum power, sharing power between stalls or stations, cable temperature, utility grid maintenance, etc.) or vehicle conditions (such as battery temperature, battery state of charge (SOC), etc.) may affect charging limits and associated charging time unbeknownst to the user.

### SUMMARY

In some configurations, an electrified vehicle includes an electric machine configured to provide torque to vehicle wheels, a traction battery coupled to the electric machine, a human-machine interface (HMI) within a cabin of the electrified vehicle, and a controller in communication with the electric machine, the traction battery, and the HMI. The controller is programmed to generate an alert in response to a difference between a vehicle charging power level request and charging power delivered by a connected external power source when the difference exceeds a corresponding threshold. The alert may be generated on the HMI and/or communicated to a mobile device associated with the electrified vehicle. The controller is further programmed to receive data including available charging stations and associated power levels, and wherein the controller generates the alert including identifying at least one of the available charging stations having a power level that exceeds the charging power delivered by the connected external power source in response to the difference between the vehicle charging power level request and the charging power delivered by the connected external power source exceeding the corresponding threshold.

In one or more configurations, the controller is further programmed to calculate an estimated charging time or charging rate (such as kw/h or km of range per minute, for example) for the at least one available charging station having a power level that exceeds the charging power delivered by the connected external power source. The alert may include the estimated charging time or charging rate as well as the estimated charging time or charging rate for the connected external power source.

Various configurations may include a connected external power source having a plurality of charging stalls with the controller programmed to generate an alert including identifying a different charging stall having a charging cord compatible with a charging port of the electrified vehicle and a higher power level than a current charging stall. The controller may be further programmed to adjust the corresponding difference threshold based on input received via the HMI or input received via a mobile device associated with the electrified vehicle.

A method for controlling an electrified vehicle having an electric machine configured to provide torque to vehicle wheels, a traction battery coupled to the electric machine and configured to receive power from an external power source, and a controller in communication with the electric machine and the traction battery, may include, by the controller: in response to a difference between charging power delivered by the external power source and a charging power requested by the electrified vehicle exceeding an associated threshold, generating an alert message including identification of a different external power source having a charging power capability that would provide a difference between the charging power requested and the charging power capability below the associated threshold. The method may further include communicating the alert message to a mobile device associated with the electric vehicle and/or to a human-machine interface (HMI) of the electrified vehicle. The method may also include estimating a charging time or charging rate for the different external power source based on the charging power capability, and communicating the estimated charging time or charging rate to at least one of an HMI of the electrified vehicle and a mobile device paired to the electrified vehicle. The method may further include estimating a distance to the different external power source from a current location of the electrified vehicle, and communicating the estimated distance to at least one of the HMI and the mobile device. Where the external power source comprises a plurality of charging stalls, the method may include identifying a charging stall different from a current charging stall.

In one or more configurations, a vehicle system includes a controller in communication with an on-board charger configured to charge a traction battery from an external power source. The traction battery is configured to power an electric machine that provides propulsive torque to vehicle wheels. The controller is programmed to generate an alert message identifying an alternative external power source that would reduce a difference between (a) power requested by the controller, and (b) power currently being delivered by the external power source when the difference exceeds a configurable threshold. The controller may be further programmed to communicate the alert message to a vehicle human-machine interface (HMI) and/or a paired or associated mobile device. The controller may be further programmed to estimate a charging time or charging rate associated with the power currently being delivered, and a charging time or charging rate associated with power capability of the alternative power source, and to communicate the estimated charging times or charging rates to the HMI. The configurable threshold may be adjusted based on input received from the HMI. The external power source may include a plurality of charging stalls with at least two of the charging stalls having different charging power capability, wherein identifying an alternative external power source comprises identifying an alternative charging stall.

Electrified vehicles, systems, and/or methods for controlling electrified vehicles as described in this disclosure may provide associated advantages. For example, alerting the vehicle driver of charging performance that is different than expected may allow the driver to move the vehicle to a different charging location to improve performance and associated customer satisfaction. Similarly, autonomous vehicles may automatically relocate to a wireless charging location that has better charging performance in response to detecting reduced charging performance at a particular location. Communicating estimated charging times or rates may provide additional information to inform decisions by the user (or autonomous vehicle) with respect to relocating the vehicle to a different charging station or location.

### BRIEF DESCRIPTION OF THE DRAWINGS

FIG. 1 is a block diagram of a representative electrified vehicle that provides vehicle charging performance notifications according to one or more embodiments.

FIG. 2 is a flowchart illustrating operation of a system or method for controlling an electrified vehicle to enhance charging performance.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the claimed subject matter. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

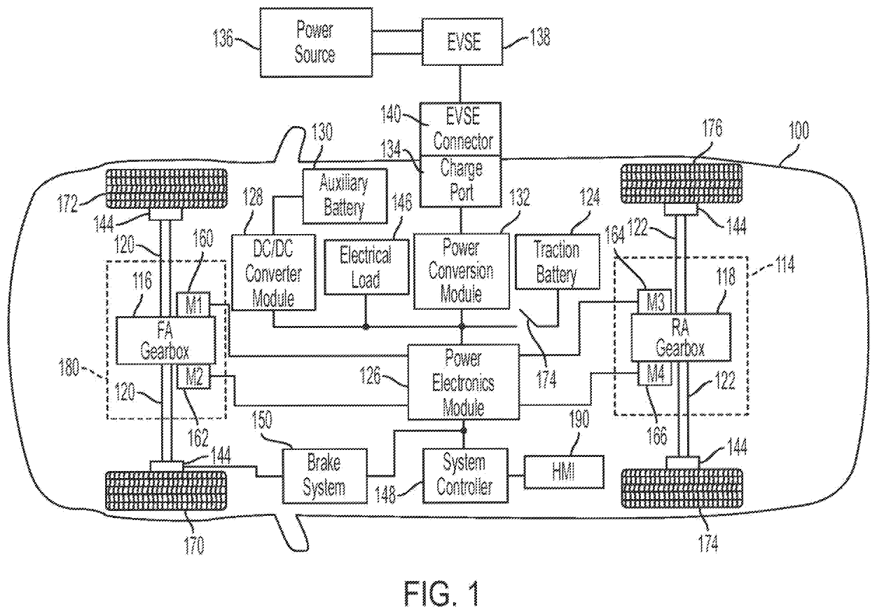

FIG. 1 depicts a representative configuration for an electrified vehicle having the ability to be charged from a coupled or connected external power source. The representative electrified vehicle is implemented as a battery-electric vehicle (BEV). A BEV 100 may comprise one or more electric machines mechanically coupled to one or more gearboxes to achieve a variety of driving configurations. One or more electric machines coupled to a gearbox may be referred to as a drive unit. A first drive unit 180 may include a first front-axle electric machine 160 and a second front-axle electric machine 162 coupled to a front-axle gearbox 116. The front-axle gearbox 116 may include one or more gears that combine the torque from the first front-axle electric machine 160 and the second front-axle electric machine 162 to provide a torque output to a differential portion of the front-axle gearbox 116. The differential portion of the front-axle gearbox 116 may be mechanically coupled to front drive shafts 120 and direct a portion of the torque to a left-side front wheel 170 and a right-side front wheel 172. In other embodiments, a single electric machine may be coupled to a front-axle gearbox to selectively provide driving torque to the associated front wheels 170, 172.

A second drive unit 182 may include a first rear-axle electric machine 164 and a second rear-axle electric machine 166 coupled to a rear-axle gearbox 114. The rear-axle gearbox 114 may include one or more gears that combine the torque from the first rear-axle electric machine 164 and the second rear-axle electric machine 166 to provide a torque output to a differential portion of the rear-axle gearbox 114. The differential portion of the rear-axle gearbox 114 may be mechanically coupled to rear drive shafts 122 and direct a portion of the torque to a left-side rear wheel 174 and a right-side rear wheel 176. In various embodiments, a single electric machine may be coupled to a rear-axle gearbox to selectively provide driving torque to the associated rear wheels 174, 176. In some configurations, the electric machines 160, 162, 164, 166 may be integrated into or near the wheel assemblies.

The electric machines 160, 162, 164, 166 may be capable of operating as a motor or a generator. The electric machines 160, 162, 164, 166 can provide a propulsion or driving torque as well as a recuperative or regenerative braking torque or holding torque capability. The electric machines 160, 162, 164, 166 may act as generators in a recuperative or regenerative braking mode to recover kinetic energy that would normally be lost as heat in a friction braking system including friction brakes 144.

An electrical energy store may be implemented by a traction battery or battery pack 124 that stores energy that can be used by the electric machines 160, 162, 164, 166. The traction battery 124 may provide a high-voltage direct current (DC) output. The traction battery 124 may be electrically coupled to one or more power electronics modules 126. One or more contactors 142 may isolate the traction battery 124 from other components when opened and connect the traction battery 124 to other components when closed. The power electronics module 126 may also be electrically coupled to the electric machines 160, 162, 164, 166 and provides the ability to bi-directionally transfer energy between the traction battery 124 and the electric machines 160, 162, 164, 166. For example, a traction battery 124 may provide a DC voltage while the electric machines 160, 162, 164, 166 may operate with a three-phase alternating current (AC) to function. The power electronics module 126 may convert the DC voltage to a three-phase AC waveform to operate the electric machines 160, 162, 164, 166. In a regenerative mode, the power electronics module 126 may convert the three-phase AC waveform from the electric machines 160, 162, 164, 166 acting as generators to a DC voltage level that is compatible with the traction battery 124.

In addition to providing energy for propulsion, the traction battery 124 may provide energy for other vehicle electrical systems. The vehicle 100 may include a DC/DC converter module 128 that converts the high-voltage DC output of the traction battery 124 to a low-voltage DC supply that is compatible with low-voltage vehicle loads. An output of the DC/DC converter module 128 may be electrically coupled to a low-voltage auxiliary battery 130 (e.g., 12V, 24V, or 48V battery). The low-voltage systems may be electrically coupled to the auxiliary battery. One or more electrical loads 146 may be coupled to the high-voltage bus. The electrical loads 146 may have an associated controller that operates and controls the electrical loads 146 when appropriate. Examples of electrical loads 146 include, but are not limited to, a heating module and/or an air-conditioning module.

The traction battery 124 may be charged by a connected external power source 136. The external power source 136 may be implemented by a connection to an electrical outlet. The external power source 136 may be electrically coupled to a charger or electric vehicle supply equipment (EVSE) 138. The external power source 136 may be an electrical power distribution network or grid as provided by an electric utility company. The EVSE 138 may provide circuitry and controls to manage the transfer of energy between the power source 136 and the vehicle 100. The external power source 136 may provide DC or AC electric power to the EVSE 138. The EVSE 138 may have a charge connector 140 for plugging into a charge port 134 of the vehicle 100. The charge port 134 may be any type of port configured to transfer power from the EVSE 138 to the vehicle 100. The charge port 134 may be electrically coupled to a charger or on-board power conversion module 132. The power conversion module 132 may condition the power supplied from the EVSE 138 to provide the proper voltage and current levels to the traction battery 124. The power conversion module 132 may interface with the EVSE 138 to coordinate the delivery of power to the vehicle 100. The EVSE connector 140 may have pins that mate with corresponding recesses of the charge port 134. Alternatively, various components described as being electrically coupled or connected may transfer power using a wireless inductive coupling. An electric energy store may alternatively be implemented by a fuel cell or similar device that converts stored energy into electrical energy.

Electrified vehicle charging stations may include various types of hardware and connection cables to interface with different vehicles having various charging capabilities or requirements. However, the same cable/connector may be used to deliver more than one voltage level, current level and either AC or DC voltage/current. Furthermore, the maximum voltage/current capability of a particular charging station may be reduced based on sharing of power between or among several stalls or cables that have a common connection to the power source. Similarly, voltage/current delivered by the charging station may be reduced based on temperature of the cable, connector, or electronics, for example. Power derating may occur for a variety of other reasons as well. Electrified vehicle 100 may also limit current below the maximum capability due to similar conditions for vehicle equipment. As such, it is often difficult for a user to determine how long it may take to achieve a particular battery state of charge (SOC) or estimated vehicle range when connected to a charging station. Furthermore, charging stations that appear to be otherwise identical to the user may have different maximum charging capability and/or may have differing conditions that result in derating power delivered to the electrified vehicle. In addition, conditions may change during a charging session that decrease the charging rate and increase the charging time. For example, a user may connect to a charging station that has a common connection to the power source for two or more stations or stalls when there are no other vehicles connected and the station/vehicle may report an estimated time for completion of charging. Any subsequently connected vehicle(s) may reduce the charging rate by one-half or two-thirds and the user may return to the vehicle to discover that the vehicle has not charged as expected. This may significantly affect the required charging time and lead to user dissatisfaction.

As described in greater detail throughout this disclosure, a controller, such as system controller 148 may be programmed to generate an alert in response to a difference between a vehicle charging power level request and the actual charging power delivered by a connected external power source 136 when the difference exceeds a corresponding threshold. The alert may identify an alternative charging station or stall with compatible charging equipment that has a higher maximum power than the currently coupled charging station so that the user may relocate the vehicle if desired to achieve the charging goal.

With continuing reference to FIG. 1, an electronically controlled braking system 150 includes one or more wheel brakes 144 coupled to the wheels 170, 172, 174, 176 to provide a friction braking torque for slowing the vehicle 100 and preventing motion of the vehicle 100. Braking or holding torque may also be provided by one or more of the electric machines 160, 162, 164, and 166. The wheel brakes 144 may be hydraulically actuated, electrically actuated, or some combination thereof. The wheel brakes 144 may be a part of a brake system 150. The brake system 150 may include other components to operate the wheel brakes 144. For simplicity, the figure depicts a single connection between the brake system 150 and one of the wheel brakes 144. A connection between the brake system 150 and the other wheel brakes 144 is implied. The brake system connections may be hydraulic and/or electrical. The brake system 150 may include a controller to monitor and coordinate operation of the wheel brakes 144. The brake system 150 may monitor the brake components and control the wheel brakes 144. The brake system 150 may respond to driver commands and may also operate autonomously to implement features such as stability control. The controller of the brake system 150 may implement a method of applying a requested brake force when requested by another controller or sub-function.

Electronic modules, controllers, and/or processors in the vehicle 100 may communicate via one or more vehicle networks. The vehicle network may include a plurality of channels for communication. One channel of the vehicle network may be a serial bus such as a Controller Area Network (CAN). One of the channels of the vehicle network may include an Ethernet network defined by Institute of Electrical and Electronics Engineers (IEEE) 802 family of standards. Additional channels of the vehicle network may include discrete connections between modules or controllers and associated actuators and sensors and may include power signals from the auxiliary battery 130. Different signals may be transferred over different channels of the vehicle network. For example, video signals may be transferred over a high-speed channel (e.g., Ethernet) while control signals may be transferred over CAN or dedicated connections. The vehicle network may include any hardware and software components that aid in transferring signals and data between modules. The vehicle network is not shown in FIG. 1 but it may be implied that the vehicle network may connect to any electronic module, controller, or processor that is present in the vehicle 100. A vehicle system controller (VSC) 148 may be present to coordinate the operation of the various components including other modules, controllers, and processors. As referred to in this disclosure, a controller or processor may refer to one or more controllers, processors, or modules that may perform distributed processing of a particular function or task. The controllers, processors, or modules may be in communication with one or more other controllers, processors, and/or modules to coordinate tasks or functions. However, the simplified description of various tasks or functions (or portions thereof) described in this disclosure may be performed by different controllers, processors, and/or modules that do not communicate or coordinate with one another as understood by those of ordinary skill in the art.

Although a BEV is depicted, other electrified vehicle technologies and hybrid technologies are possible. For example, the vehicle may be a fuel cell vehicle. The fuel cell vehicle may include a fuel cell as a primary energy source while the traction battery 124 acts as a secondary energy source. The fuel cell vehicle may be a plug-in type that permits recharging of the traction battery 124. The vehicle may be a hybrid vehicle that includes an engine and an electric drive capability with a plug-in charging capability. Any references to a plug-in capability apply equally to hands-free, no-contact, or wireless charging capability using inductive, capacitive or other wireless coupling that do not require a physical cable/plug/receptacle, but may require other compatible hardware that may affect charging capability and/or rate. The implementations described herein may be applicable to any vehicles that include an electric drive having one or more electric machines that may be controlled to provide driving torque and selectively powered by a traction battery.

In some configurations, the electric machines 160, 162, 164, 166 may each be configured to provide propulsion torque to drive wheels of the vehicle 100. Various combinations of the electric machines 160, 162, 164, 166 are possible. Configurations may be implemented having from one to four electric machines, for example.

For example, the vehicle 100 may be configured to be a rear-wheel drive (RWD) vehicle in which an electric drive unit is coupled to a rear axle of the vehicle. The RWD vehicle may include only the first rear-axle electric machine 164. In some configurations, the RWD vehicle may include the first rear-axle electric machine 164 and the second rear-axle electric machine 166. In the RWD vehicle, the first front-axle electric machine 160, the second front-axle electric machine 162, and the front-axle gearbox 116 may be omitted.

As another example, the vehicle 100 may be configured as a front-wheel drive (FWD) vehicle in which a drivetrain is coupled to a front axle of the vehicle. The FWD vehicle may include only the first front-axle electric machine 160. In some configurations, the FWD vehicle may include the first front-axle electric machine 160 and the second front-axle electric machine 162. In the FWD vehicle, the first rear-axle electric machine 164, the second rear-axle electric machine 166, and the rear-axle gearbox 118 may be omitted. Similarly, the vehicle 100 depicted in FIG. 1 may be implemented as an all-wheel drive (AWD) vehicle. In some configurations, the second front-axle electric machine 162 may be omitted (e.g, one electric machine on the front axle and two electric machines on the rear axle). In some configurations, the second rear-axle electric machine 166 may be omitted (e.g, one electric machine on the rear axle and two electric machines on the front axle). In some configurations, the second front-axle electric machine 162 and the second rear-axle electric machine 166 may be omitted (e.g., only one electric machine per axle). The particular configuration may be selected for desired performance and handling characteristics of the vehicle.

The front-axle gearbox 116 and the rear-axle gearbox 118 may have different gear ratios. The gear ratios of one gearbox may be configured to output high torque at low speeds. The other gearbox may be configured with a gear ratio optimized for highway cruising speeds. As such, the front-axle gearbox 116 and the rear-axle gearbox 116 may have different operating characteristics.

Vehicle 100 may include a human-machine interface (HMI) 190 in communication with system controller 148. HMI 190 may receive operator input to select or activate a configurable difference threshold to trigger an alert message when the difference between a vehicle charging power level request and charging power delivered by a connected external power source exceed the threshold. Other options associated with charging performance notifications and identification of alternative external charging locations (such as distance from current location, difference in charging rate/time, etc.) may be selected or entered via HMI 190. Electrified vehicle 100 may also include an infotainment and/or telematics system having wireless communications capability to communicate with an associated mobile wired or wireless device, such as a smart phone, computer, tablet, etc. The associated or paired mobile device may also be used to receive alerts/messages as well as to enter or select configuration options as described herein.

As shown in the representative example of FIG. 1, an electrified vehicle 100 includes an electric machine 160-166 to provide torque to the vehicle wheels 170-176, a traction battery 124 selectively coupled to the electric machine 160-166, an HMI 190 within a cabin of the electrified vehicle 100, and a controller 148 in communication with the electric machine 160-166, the traction battery 124, and the HMI 190, the controller 148 programmed to generate an alert in response to a difference between a vehicle charging power level request and charging power delivered by a connected external power source 130 when the difference exceeds a corresponding threshold. The alert may be generated on the HMI 190 and/or may be communicated to a mobile device associated with the electrified vehicle. Electrified vehicle 100 may access previously stored data from an associated memory and/or wirelessly access data via a Wi-Fi, cellular, and/or satellite network, for example, including available charging stations and associated charging parameters, which may include hardware/plug compatibility, charging power/rate capability, location, etc. Controller 148 may calculate an estimated charging time and/or charging rate for the current charging station and/or at least one available charging station and provide associated information in an alert message communicated via the HMI 190 and/or an associated mobile device.

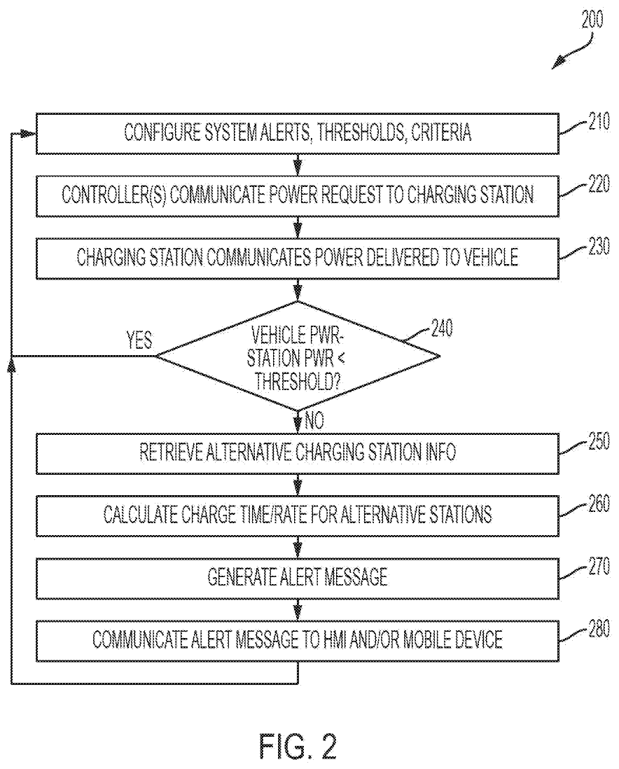

FIG. 2 illustrates operation of a system or method for controlling an electrified vehicle to monitor traction battery charging and provide associated charging performance notifications. Control logic or functions performed by or distributed among one or more controllers, modules, processors, etc. is generally represented in the diagram of FIG. 2. This illustration provides a representative control strategy, algorithm, and/or logic that may be implemented using one or more processing strategies such as event-driven, interrupt-driven, multi-tasking, multi-threading, and the like. As such, various steps or functions illustrated may be performed in the sequence illustrated, in another sequence, in parallel, or in some cases omitted. Although not always explicitly illustrated, one of ordinary skill in the art will recognize that one or more of the illustrated steps or functions may be repeatedly performed individually and/or in combination. Similarly, the order of processing is not necessarily required to achieve the features and advantages of the claimed subject matter as described herein, but is provided for ease of illustration and description. The control logic may be implemented primarily in software executed by a microprocessor-based vehicle, engine, electric machine, and/or powertrain controllers, generally represented by system controller 148 of FIG. 1. Of course, the control logic may be implemented in software, hardware, or a combination of software and hardware in one or more controllers depending upon the particular application. When implemented in software, the control logic may be provided in one or more non-transitory computer-readable storage devices or media having stored data representing code or instructions executed by a computer to control the vehicle or its subsystems. The computer-readable storage devices or media may include one or more of a number of known physical devices which utilize solid state, electric, magnetic, and/or optical storage to keep executable instructions and associated calibration information, operating variables, and the like.

Representative control logic or algorithm 200 begins at block 210 where one or more system alerts, thresholds, messages, etc. may be configured using the vehicle HMI and/or an associated mobile device, such as a smart phone, tablet, or computer, for example. Representative parameters may include a difference threshold that determines when to trigger an alert message indicating that charging station power delivery is less than the power requested by the vehicle, the distance/range of a higher power charging station relative to the current vehicle location for including the higher power charging station as a suggested alternative, compatible vehicle hardware (e.g. if the user has a charging plug adapter suitable for more than one type of connection), selection of devices to communicate an alert, etc. A requested vehicle charging power/rate is determined as represented at 220. The requested vehicle power/rate may depend on various vehicle and/or ambient conditions such as current battery SOC, battery temperature, ambient temperature, etc. The electrified vehicle may establish data communication with the charging station to request a power level and monitor charging status via the charging cable and/or wireless charging connection as generally understood by those of ordinary skill in the art. The charging station determines a negotiated power for delivery and the electrified vehicle monitors the power being delivered as represented at 230. The vehicle controller determines whether the difference between the vehicle-requested power and the station-delivered power exceeds a corresponding threshold as represented at 240. Although a single threshold is illustrated, multiple thresholds may be provided with different associated actions depending on the particular application and implementation. One or more of the thresholds and various other parameters may be user configurable as previously described. If the difference is less than the threshold, control returns to step 210.

When the difference exceeds the associated threshold at 240, alternative charging station information is retrieved as represented at 250. Charging station information may include a maximum power capability, connection hardware compatibility, location, whether the station is shared or dedicated, current availability, fees, subscriber network participation, etc. The alternative charging station information may be retrieved from a database previously stored on-board the vehicle and/or may be retrieved over a wireless cellular, satellite, Wi-Fi, or similar connection from a public or private network/server. The alternative charging station information may be used at 260 to calculate an associated charging time/rate/fees etc. to identify or select one or more alternative charging stations that satisfy the user configurable (or default) criteria entered at 210. Other information, such as location, distance from current vehicle location, hardware compatibility, subscriber network, etc. may also be used as criteria for comparing the current external charging source to an alternative charging source, station, stall, etc.

An alert message is generated as represented at 270. The alert message may be informational only, i.e. the charging station is delivering less power than your vehicle is requesting and may result in additional charging time. The alert message may also include alternative charging locations that match user selected criteria as previously described. The alert message is then communicated to the vehicle HMI and/or one or more associated mobile devices as represented at 280. Control then returns to step 210.

As generally illustrated in FIGS. 1-2, a method for controlling an electrified vehicle 100 having an electric machine 160-164 configured to provide torque to vehicle wheels 170-176, a traction battery 124 coupled to the electric machine 160-164 and configured to receive power from an external power source 136, and a controller 148 in communication with the electric machine 160-164 and the traction battery 124 includes, by one or more controllers represented by the controller 148: in response to a difference between charging power delivered by the external power source and a charging power requested by the electrified vehicle exceeding an associated threshold 240, generating an alert message 270 including identification of a different external power source 250 having a charging power capability that would provide a difference between the charging power requested and the charging power capability below the associated threshold.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information stored on various types of non-transitory storage media including information permanently stored on non-writable storage media such as ROM devices and information alterably stored on writeable storage media such as optical, magnetic, or solid state media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software, and firmware components.

While representative embodiments are described above, it is not intended that these embodiments describe all possible forms encompassed by the claims. The words used in the specification are words of description rather than limitation, and it is understood that various changes can be made without departing from the claimed subject matter. As previously described, the features of various representative embodiments can be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to strength, durability, life cycle, marketability, appearance, packaging, size, serviceability, weight, manufacturability, ease of assembly, etc. As such, embodiments described as less desirable than other embodiments or prior art implementations with respect to one or more characteristics are not necessarily outside the scope of the disclosure or claimed subject matter and may be desirable for particular applications.

What is claimed is:

1. An electrified vehicle comprising:
an electric machine configured to provide torque to vehicle wheels;
a traction battery coupled to the electric machine;
a human-machine interface (HMI) within a cabin of the electrified vehicle; and
a controller in communication with the electric machine, the traction battery, and the HMI, the controller programmed to generate an alert in response to a difference between a vehicle charging power level request and charging power delivered by a connected external power source when the difference exceeds a corresponding threshold.

2. The electrified vehicle of claim 1 wherein the alert is generated on the HMI.

3. The electrified vehicle of claim 2 wherein the controller communicates the alert to a mobile device associated with the electrified vehicle.

4. The electrified vehicle of claim 1 wherein the controller communicates the alert to a mobile device associated with the electrified vehicle.

5. The electrified vehicle of claim 1 wherein the controller is further programmed to receive data including available charging stations and associated power levels, and wherein the controller generates the alert including identifying at least one of the available charging stations having a power level that exceeds the charging power delivered by the connected external power source in response to the difference between the vehicle charging power level request and the charging power delivered by the connected external power source exceeding the corresponding threshold.

6. The electrified vehicle of claim 5 wherein the controller is further programmed to calculate an estimated charging time or charging rate for the at least one available charging station having a power level that exceeds the charging power delivered by the connected external power source, and wherein the alert includes the estimated charging time or charging rate.

7. The electrified vehicle of claim 6 wherein the controller is further programmed to calculate an estimated charging time or charging rate for the charging power delivered by the connected external power source, and wherein the alert further includes the estimated charging time or charging rate of the connected external power source.

8. The electrified vehicle of claim 1 wherein the connected external power source includes a plurality of charging stalls and wherein the controller is further programmed to generate the alert including identifying a different charging stall having a charging cord compatible with a charging port of the electrified vehicle and a higher power level than a current charging stall when the difference between the vehicle charging power level request and the charging power delivered by the connected external charging source exceeds the corresponding threshold.

9. The electrified vehicle of claim 1 wherein the controller is further programmed to adjust the corresponding threshold based on input received via the HMI or input received via a mobile device associated with the electrified vehicle.

10. A method for controlling an electrified vehicle having an electric machine configured to provide torque to vehicle wheels, a traction battery coupled to the electric machine and configured to receive power from an external power source, and a controller in communication with the electric machine and the traction battery, the method comprising, by the controller:
in response to a difference between charging power delivered by the external power source and a charging power requested by the electrified vehicle exceeding an associated threshold, generating an alert message including identification of a different external power source having a charging power capability that would provide a difference between the charging power requested and the charging power capability below the associated threshold.

11. The method of claim 10 further comprising communicating the alert message to a mobile device associated with the electric vehicle.

12. The method of claim 10 further comprising communicating the alert message to a human-machine interface (HMI) of the electrified vehicle.

13. The method of claim 10 further comprising:
estimating a charging time or charging rate for the different external power source based on the charging power capability; and
communicating the estimated charging time or charging rate to at least one of an HMI of the electrified vehicle and a mobile device paired to the electrified vehicle.

14. The method of claim 13 further comprising:
estimating a distance to the different external power source from a current location of the electrified vehicle; and
communicating the estimated distance to at least one of the HMI and the mobile device.

15. The method of claim 13 wherein the external power source comprises a plurality of charging stalls and wherein the different external power source comprises a charging stall different from a current charging stall.

16. A vehicle system comprising:
a controller in communication with an on-board charger configured to charge a traction battery from an external power source, the traction battery being configured to power an electric machine that provides propulsive torque to vehicle wheels, the controller programmed to generate an alert message identifying an alternative external power source that would reduce a difference between (a) power requested by the controller, and (b) power currently being delivered by the external power source when the difference exceeds a configurable threshold.

17. The vehicle system of claim 16 wherein the controller is further programmed to communicate the alert message to a vehicle human-machine interface (HMI).

18. The vehicle system of claim 17 wherein the controller is further programmed to estimate a charging time or charging rate associated with the power currently being delivered, and a charging time or charging rate associated with power capability of the alternative power source, and to communicate the estimated charging times or charging rates to the HMI.

19. The vehicle system of claim 18 wherein the configurable threshold is adjusted based on input received from the HMI.

20. The vehicle system of claim 19 wherein the external power source comprises a plurality of charging stalls with at least two of the charging stalls having different charging power capability, and wherein identifying an alternative external power source comprises identifying an alternative charging stall.
